(19) United States
(12) Patent Application Publication
(10) Pub. No.: US 2003/0084514 A1
(43) Pub. Date: May 8, 2003

(54) Method of dewrinkling fabrics

(76) Inventors: Marie S. Chan, Forest City, NC (US); William S. Parks, Boiling Springs, SC (US)

Correspondence Address: Milliken & Company, P. O. Box 1927, Spartanburg, SC, 29304, US

(21) Appl. No.: 09/919,194

(22) Filed: Jul. 31, 2001

(51) Int. Cl. D06M 10/00; C11D 1/00

(52) U.S. Cl. 8/115.51; 510/513; 510/516

(57) ABSTRACT

Specific methods of dewrinkling fabrics (such as garments, tablecloths, and the like) through a spray-treatment with aqueous formulations of non-film producing fiber lubricants are provided. Such a method provides a relatively simple, yet highly effective manner of removing wrinkles from fabrics and also, since films are not produced on the surface of the target fabric substrate, of also permitting greater rewrinkling resistance to the treated fabric itself. A fabric treated in accordance with this method is also provided.

### FIELD OF THE INVENTION

This invention relates to specific methods of dewrinkling fabrics (such as garments, tablecloths, and the like) through a spray-treatment with aqueous formulations of non-film producing fiber lubricants. Such a method provides a relatively simple, yet highly effective manner of removing wrinkles from fabrics and also, since films are not produced on the surface of the target fabric substrate, of reducing the rewrinkling capability of the treated fabric itself. A fabric treated in accordance with this method is also provided.

### DISCUSSION OF THE PRIOR ART

All U.S. patents cited below are herein fully incorporated by reference.

Aesthetics have dictated the need for garments, tablecloths, and the like, that do not exhibit an appreciable, unsightly wrinkled appearance. Fabrics include individual yarns that tend to be easily manipulated during wear and/or use by numerous factors (including simple reactions to movement, static electricity, and the like) into differing and non-uniform configurations after washing, drying, storage, and the like. After such manipulation, it appears that the yarns do not easily relax into their intended orientations due to surface defects (roughening) and stray fibers and fibrils present on the individual yarns that function to hold the yarns in place and prevent further movement of the yarns. With such nonuniformly manipulated and held yarns, the resultant effect is the generation of the aforementioned wrinkled appearance. Since most fabrics tend to produce such unsightly wrinkles, and since general fashion trends and public tastes prompt wearers and users to reduce the wrinkled appearances of such fabrics to the greatest extent possible, there is a need within the fabric industry, more specifically the garment and similar industries, to facilitate wrinkle reduction to the end user. Of further need is such a procedure that also provides a certain degree of prevention of rewrinkling to the target fabric during wear and/or use since the initial removal of wrinkles helps prior to such wear and/or use. The ability to prevent the propagation of wrinkles subsequent to the initial removal thus would provide a more thorough and desirable treatment to the end-user.

The most popular manner of providing wrinkle reductions in fabrics is through the utilization of moisture to re-manipulate the individual fibers into their originally intended configurations. Various procedures of moisture-application to fabrics for this purpose have been developed and followed in the past. For example, steam ironing is the most prevalent wrinkle reduction process for fabrics. As is well known, such a process involves the application of moisture to a fabric under heat to set the fibers into a desired arrangement. Unfortunately, such a procedure is not always desired due to the potential hazards associated therewith as well as the time required to effectuate the desired level of dewrinkling and pressing of the target fabric. Ironing requires either setting up a permanent ironing station complete with ironing board and iron, or that one has to be set up on each occasion that they are needed. Both time and effort are involved including time to heat up the iron and the attention to unplug it to eliminate fire hazard. Furthermore, such ironing is not permanent and only provides rewrinkling prevention upon additional starching or similar treatments. Another method commonly employed would be to re-introduce the garment or article back into the dryer for another cycle. This practice is both time consuming and energy intensive. Safer and quicker alternatives to such ironing or re-drying processes do exist.

For example, to avoid any methods of removing wrinkles at all, there have been developed certain fabrics which exhibit wrinkle-free (or at least nearly wrinkle-free) characteristics through specific fiber and/or fabric manufacturing procedures. These include, heat-setting or cross-linking of fibers into configurations that are not easily altered, such as taught within U.S. Pat. No. 4,818,243 to Chance et al., U.S. Pat. No. 4,304,564 to Frick, Jr. et al., and U.S. Pat. No. 4,619,668 to Frick, Jr. et al., utilizing substantially antistatic fiber components to prevent manipulation of such fibers, as in U.S. Pat. No. 3,560,419 to Crovatt, Jr. et al., and applying permanent or semi-permanent finishes to the target fabric surface and/or to the individual fibers, as in U.S. Pat. No. 5,320,645 to Logue et al. The vast majority of fabrics within the broad garment, etc., markets, however, do not include such technological advancements due to higher costs, potentially environmentally harmful chemicals, comfort problems, and overall fashion trends.

As well, there are certain spray applications and techniques that have been developed for wrinkle removal within fabrics that are easier and generally safer than steam-ironing. As merely examples, aerosol sprays of simple, short-chain alcohols, distilled water, and propellants have been taught within U.S. Pat. No. 3,600,325 to Kaufman et al.; aqueous short chain-alcohols with cationic surfactants have been developed within U.S. Pat. No. 3,674,688 to Schwartz et al; aqueous short-chain alcohols with glycerine and nonionic surfactants are known within U.S. Pat. No. 4,806,254 to Church; and, most recently, work has been undertaken to utilize silicones and siliconates as wrinkle-reducing agents as in U.S. Pat. No. 4,800,026 to Coffindaffer et al., U.S. Pat. No. 5,100,566 to Agbomeirele et al., and U.S. Pat. No. 5,798,107 to Vogel et al. Although such alternatives have shown some promise as dewrinkling agents and processes, they still have their own drawbacks. Aerosols are generally disliked due to the well known ozone-depletion problems associated with certain propellants and compositions of alcohols and water alone are not effective at reducing rewrinkling possibilities since the components evaporate rather quickly after deposition on the fabric surface. Furthermore, alcohols are potentially toxic to users and due to the need for evaporation of such a liquid component, invariably results in the release of potentially unwanted and harmful chemicals into the environment. Cationic surfactants are known to pose certain toxicity problems as well and, in combination with water and alcohol, are not effective from a rewrinkling perspective either. Glycerine is undesirable due to the potential for applying a tacky finish to the fabric surface as well as requiring preservatives to protect such contents during storage and thus the need for further, potentially expensive additives (e.g., silicones, for example) to reduce this effect. Furthermore, such a component leaves an oily or greasy residue which is easily transfers to the wearer's skin upon contact therewith. Additionally, the noted silicones and siliconates are undesirable due to high costs, are not generally biodegradable, and resulting problems with producing of starchy, rigid films on the target fabric to provide a wrinkle-free appearance. Such films easily disintegrate or deform in discrete locations upon wearing and use thereby reducing the ability of such compositions and procedures to reduce the chances of rewrinkling within the target fabric. Thus, although certain relatively simple application methods for the dewrinkling of fabrics exist, none are available or taught within the prior art that avoids all of these potential problems. Such an improved simplified dewrinkling method that does not require high cost additives therein, and that also provides anti-rewrinkling characteristics to the target fabric is highly desirable. To date, the methods and formulations discussed above are the most effective dewrinkling procedures disclosed and available to the industry.

### DESCRIPTION OF THE INVENTION

It is thus an object of the invention to provide an effective easy-to-use procedure of simply spraying a two-component composition to a target fabric in order to remove wrinkles therein. Another object of the invention is to provide a process which not only reduces the wrinkled appearance of target fabrics, but also provides a desirable level of effectiveness in reducing the ability of such fabrics to rewrinkle upon further and standard wear and/or use. Yet another object of this invention is to provide a relatively inexpensive, environmentally friendly, simple-to-use, fast-acting fabric dewrinkling composition and method.

Accordingly, this invention encompasses a method of dewrinkling fabrics through the spray-contacting of a target fabric with a non-film forming composition comprising water and at least one fiber lubricant/plasticizer and allowing the target fabric subsequently to dry, wherein said fiber lubricant/plasticizer is selected from the group of lubricating/plasticizing agents consisting of high density polyolefin waxes, at least one compound that conforms with the following Formula (A)

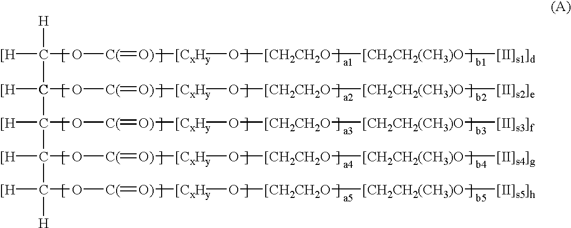

wherein d=f=h=1; e=0 or 1; g=0 or 1; 2≦x≦20; (2x−4)≦y≦2x; and

$$Σ {a}_{i} >= 8 and \frac{Σ {a}_{i} ( 44 )}{Σ {a}_{i} ( 44 ) + Σ {b}_{i} ( 56 )} >= 0.6 ;$$

wherein structure [II] is H, CH₃, or

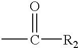

wherein R₂=CₚH_{q} such that 1≦p≦20, 2p−3≦q≦2p+1, and sᵢ=0 or 1; at least one compound that conforms with the following Formula (B)

[I]-[CH₂CH₂O—]ₐᵢ—[CH₂CH₂(CH₃)O—]_{bi}-[II]ₛᵢ (B)

wherein structure [I] is H, CH₃O, or R₁(O)_{c};

wherein R₁=CₙHₘ, and 2≦n≦20, (2n−4)≦m≦2n+1, 1≦c≦5, and

$$Σ {a}_{i} \geq 8 and \frac{Σ {a}_{i} ( 44 )}{Σ {a}_{i} ( 44 ) + Σ {b}_{i} ( 56 )} \geq 0.6 ;$$

wherein and Structure [II] is H, CH₃, or

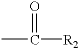

wherein R₂=CₚH_{q} such that 1≦p≦20, 2p−3≦q≦2p+1, and sᵢ=0 or 1;

wherein when Structure I is not H or CH₃, or Structure II is not H or CH₃, then 1≦i≦c

$$Σ {a}_{i} \geq 8 and \frac{Σ {a}_{i} ( 44 )}{Σ {a}_{i} ( 44 ) + Σ {b}_{i} ( 56 )} \geq 0.6 ;$$

wherein when Structure I is H or CH₃O and Structure II is H, then i=1 and a(44)+b(56)≧8000 and

$$\frac{a ( 44 )}{a ( 44 ) + b ( 56 )} \geq 0.6 ;$$

and any mixtures thereof. Preferably, such a fiber lubricant/plasticizer exhibits a hydrophilic/lipophilic balance (HLB) of greater than or equal to 8.0. The fabric treated by such a method is also encompassed within this invention.

The term “non-film forming” is intended to mean lack of producing any actual continuous polymeric film on the fabric surface or to cover a plurality of individual yarns of the target fabric. As noted above, such a film, although it may provide a certain degree of rigidity and thus support to maintain yarn orientation, the main problem realized with such a film is that it is easily deformed in discrete places during wear and/or use, leaving the remaining portions of the film intact. With such a discrete loss in film integrity, the rewrinkling ability of the fabric is increased and such occurs with relative ease after normal wear and/or use in such an instance (the effect is similar to crumpling paper). To the contrary, the current development requires the mere spray-application of a nonionic fiber lubricant/plasticizer component in mixture with a water carrier to a target fabric surface. Without intending to be bound to any specific scientific theory, it is believed that the fiber lubricant/plasticizer component actually works with the water first to dissipate any static electrical charges, as well as to lubricate the individual yarns (and fibers) to permit the yarns to slide over any roughened or misshapen fibers and fibrils back into their originally intended orientation. More importantly, such a component remains in contact with the yarns and is not easily removed through normal wear and/or use, thus providing a continuous lubrication and wrinkle release effect. The water carrier is easily removed through evaporation; however, its presence is not only not desirable (due to the wet feel accorded the fabric after spray-application thereof), but is also unnecessary to effectuate the desired long-term anti-rewrinkling properties. Again, the nonionic fiber lubricant/plasticizer component(s) remain in contact with the yarns a sufficient amount of time to permit the required fiber and yarn friction reduction to prevent rewrinkling due to normal wear and /or use. Thus, again, the formation of a film to provide integrity to the fabric is unnecessary and, in this instance, works against the desired ability to provide anti-rewrinkling characteristics to the treated target fabric.

Although water is a required carrier component, other vehicles may be admixed therewith if desired including alcohols and other easily evaporated solvents. However, it is most highly preferred to have a simplified composition of water as the sole carrier component in order to provide an environmentally friendly formulation and to reduce the costs involved in producing such a composition.

In addition, other components may be present as well, including, without limitation, antistatic agents, preservatives, fragrances, perfumes, colorants, chelating agents, wetting agents, surfactants, antimicrobial agents, other fiber lubricating compounds, and the like. Of particular importance are physical property modifiers such as rheology, viscosity, and the like modifiers, in order to permit better spray-application of the liquid composition directly onto a arget fabric surface. Relatively expensive and/or potentially toxic or regulated components such as silicones, cationic surfactants, methanol, ethanol, isopropanol, and the like, are highly discouraged and therefore should not be added to the inventive compositions and used within the inventive methods (although small amounts of certain ingredients, such as alcohols, may be present such that their individual or collective presence is still within the scope of the invention as long as the required components of water and lubricant/plasticizer are also present).

The all-important fiber lubricant/plasticizer is most broadly defined as either a high density polyolefin wax (high density polyethylene, for example) or any number of different nonionic compounds meeting the criteria set forth below for Formulae (A) or (B at least one compound that conform-ms with the following Formula (A)

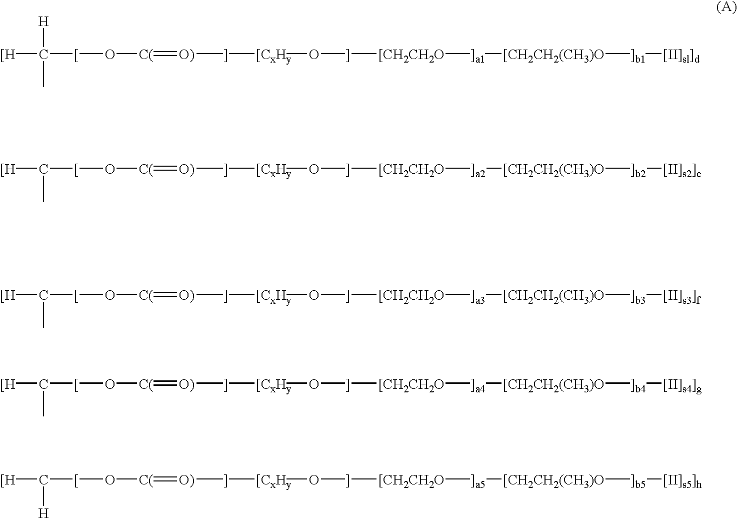

wherein d=f=h=1; e=0 or 1; g=0 or 1; 2≦x≦20; (2x−4)≦y≦2x; and

$$Σ {a}_{i} >= 8 and \frac{Σ {a}_{i} ( 44 )}{Σ {a}_{i} ( 44 ) + Σ {b}_{i} ( 56 )} >= 0.6 ;$$

wherein structure [II] is H, CH₃, or

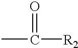

wherein R₂=CₚH_{q} such that 1≦p≦20, 2p−3≦q≦2p+1, and sᵢ=0 or 1; at least one compound that conforms with the following Formula (B)

[I]-[CH₂CH₂O—]ₐᵢ—[CH₂CH₂(CH₃)O—]_{bi}-[II]ₛᵢ (B)

wherein structure [I] is H, CH₃O, or R₁(O)_{c};

wherein R₁=CₙHₘ, and 2≦n≦20, (2n−4)≦m≦2n+1, 1≦c≦5, and

$$Σ {a}_{i} \geq 8 and \frac{Σ {a}_{i} ( 44 )}{Σ {a}_{i} ( 44 ) + Σ {b}_{i} ( 56 )} \geq 0.6 ;$$

wherein and Structure [II] is H, CH₃, or

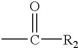

wherein R₂=CₚH_{q} such that 1≦p≦20, 2p−3≦q≦2p+1, and sᵢ=0 or 1;

wherein when Structure I is not H or CH₃, or Structure II is not H or CH₃, then 1≦i≦c

$$Σ {a}_{i} \geq 8 and \frac{Σ {a}_{i} ( 44 )}{Σ {a}_{i} ( 44 ) + Σ {b}_{i} ( 56 )} \geq 0.6 ;$$

wherein when Structure I is H or CH₃O and Structure II is H, then i=1 and a(44)+b(56)≧8000 and

$$\frac{a ( 44 )}{a ( 44 ) + b ( 56 )} \geq 0.6 ;$$

and any mixtures thereof. Such a specific definition encompasses a number of possible compounds; however, again, the resultant composition must not form a film structure and the compounds must act in such a manner as to provide some dewrinkling effect to a target fabric. Of the particular nonionic species encompassed within this invention, alkoxylated fatty acid esters (such as alkoxylated stearic acid), alkoxylated fatty acid esters (such as ethoxylated esterified castor oil), polyoxyalkylene waxes (such as alkoxylated castor oil), emulsified high density polyethylenes, alkoxylated alcohols (such as ethylene oxide/propylene oxide block copolymers), as well as certain blends of such compounds with other compounds, such as phosphate salts, high density polyolefin waxes, and the like, are preferred. The amount of the fiber lubricant/plasticizer present within the aqueous composition ranges from 0.001 to 10% by weight of the total composition itself. Preferably, such an amount is from about 0.1 to about 5% by weight; more preferably from about 0.5 to about 3%; and still more preferably from about 0.75% to about 2.5% by weight. Some particularly preferred compounds are listed below in the following table (EO represents ethylene oxide and PO represents propylene oxide; and CO represents castor oil):

Preferred Fiber Lubricant/Plasticizer Components

| Ex. | Chemical Structure and/or Tradename; Supplier; HLB # | (% by wt) |
|---|---|---|
| 1 | CO (200 EO) (Syn Lube ® 106; Milliken & Company) (18.3) | 2 |
| 2 | Coco ester of CO (16 EO) (Syn Lube ® 1632H) (8.2) | 2 |
| 3 | Oleic acid diester of CO (27EO) (Syn Lube ® 728) (9.4) | 2 |
| 4 | EO/PO block copolymer (Pluronic ® F-88; Rohm & Haas) (16) | 2 |
| 5 | EO/PO block copolymer (Pluronic ® F-68) (12) | 0.8 |
| 6 | EO/PO block copolymer (Pluronic ® F-68) (12) | 2 |
| 7 | EO/PO random copolymer plus C₁₂₋₁₄ phosphate salts (Syn Lube ® 603B) | 2 |
| 8 | High density polyethylene (Mykon ® HD; Omnivar) (9) | 2 |
| 9 | Stearic Acid (15 EO) (Leveler ® 528; Milliken) (14.0) | 2 |
| 10 | Stearic Acid (5 EO) (11.1) | 2 |
| 11 | Mixture of ethoxylated methanol esters (9.8)^{a} | 2 |
| 12 | EO/PO random copolymer (Atlas ® SF 131; Atlas Chemical) (?) | 2 |

^{a}50/50 mixture of methanol (5 EO) lauric acid ester and methanol (9 EO) lauric acid ester

Of particular interest are those compounds that exhibit an HLB of greater than or equal to 8.0. Such compounds mix well with the water carrier and thus more easily penetrate the target yarns and fibers upon spray-application. Upon contact with the yarns and/or fibers, as discussed above, the compounds appear to, again without intending to be bound to any specific scientific theory, contact with and become adhered to the fibers and/or yarns themselves. Upon contact and adhesion, it appears that such components reduce the friction of the roughened, frayed, etc., fibers and/or fibrils, thereby permitting the yarns and/or fibers to relax back into their originally intended orientations. Such dewrinkling mechanics are provided by the prior art compositions and methods as well; however, the fact that such a composition does not rely upon a film to provide rigidity to the oriented yarns and fibers, as well as the fact that such specific fiber lubricants/plasticizers do not easily evaporate or otherwise leave the fabric, yarn, and/or fiber surface (and therefore remains attached thereto providing effective yarn friction reduction over the duration of such contact and adhesion), such a simple, cost-effective, easy-to-use, environmentally friendly, composition is a significant improvement in this industry.

The term “spray-application” or “spray-applied” is intended to encompass the application of such compositions to target fabrics through the utilization of a spray-trigger mechanism and/or device as is well known in the art. Such a mechanism and/or device provides an effective manner of uniformly dispersing droplets of the composition over a relatively broad surface area of a target substrate. In such a manner, a more controlled approach to applying such a composition is provided since very small amounts of the actual active ingredient (e.g., the fiber lubricant/plasticizer) is necessary to effectuate the desired dewrinkling and anti-rewrinkling properties to the fabric. Thus, atomization, droplet formation and application on an even basis, and other non-limiting and similar spraying techniques are encompassed by such a term.

The method itself may also require a simple rubbing, brushing, flattening of the target fabric surface after spray-application, followed by drying time to permit the water (and other potential carrier) to evaporate from the surface and thus provide a comfortable, dry, dewrinkled fabric (such as a garment, tablecloth, etc.). Pulling taut the treated fabric should also suffice.

The target fabrics may be of any type that exhibits a propensity for wrinkling, including those made from cotton, polyester, polyarnide, ramie, wool, linen, and the like, as well as blends made therefrom.

### DESCRIPTION OF THE PREFERRED EMBODIMENT

The following non-limiting examples are indicative of the preferred embodiments of this invention and are compared with certain prior art teachings.

The compositions noted in the Table of Preferred Fiber Lubricant/Plasticizer compounds were then applied to cotton fabrics which initially exhibited very wrinkled appearances. Comparisons with control, water alone, and a commercially available Downy® Wrinkle Release product (from The Procter & Gamble Company and comprising the silicone-based technology of the aforementioned patents) were also tested. The tested fabrics (100% cotton T-shirts, and cotton khaki fabrics) all exhibited initial wrinkled appearances of 1.0 as defined by AATCC Test Method 124-1996, “Appearance of Fabrics after Repeated Home Laundering,” incorporated herein by reference. The test compositions were then spray-applied to the test fabric surfaces through the utilization of a trigger spray bottle (the same used by Procter & Gamble for the comparison Downy® product). The fabrics were sprayed each with from 3 to 5 quick sprays of the test compositions, were pulled taut in various directions (to facilitate movement of the individual fibers to the intended orientations), and then were allowed to dry for 2 minutes at room temperature. A second assessment of the wrinkled appearance for each test fabric was then made in relation to the aforementioned AATCC Wrinkled Appearance Rating Test to determine the effectiveness of the dewrinkling compositions and methods as the example fabric shirts were placed on regular hangers for viewing. The results are as follows (with a rating of 5 the best and a rating of 1 the worst):

EXPERIMENTAL TABLE 1

| Example (from Table above or | |
|---|---|
| comparison type) | Final Appearance Rating |
| 1 | 5.0 |
| 2 | 4.0 |
| 3 | 4.0 |
| 4 | 4.0 |
| 5 | 5.0 |
| 6 | 4.5 |
| 7 | 5.0 |
| 8 | 4.5 |
| 9 | 3.5 |
| 10 | 4.0 |
| 11 | 3.5 |
| 12 | 4.0 |
| (Comparatives) | |
| Control (no Applications) | 1.0 |
| Water Alone | 3.5 |
| Downy ® Wrinkle Release | 4.0 |
| Glycerine | 3.5 |

Thus, the inventive compositions and methods performed as well as or better than the commercially available formulation and water alone.

Some of these inventive examples and the commerically available example were then further tested to determine the ability of the compositions and applications to potentially reduce rewrinkling in the test fabrics. The cotton T-shirts were loosely wadded (not folded) and individually left on a level surface (separate from one another) for 30 minutes at room temperature. Subsequently, the shirts were then shaken loose and hung up on hangers. The same AATCC Wrinkled Appearance Rating Test was then used to asses the appearance and condition of the resultant fabrics at that time. The results were:

EXPERIMENTAL TABLE 2

| Example (from Table above or | |
|---|---|
| comparison type) | Final Appearance Rating |
| 1 | ˜3.5-4.0 |
| 2 | 3.5 |
| (Comparative) | 2.5 |
| Downy ® Wrinkle Release | |

Thus, as discussed above in greater detail, the film-forming commercially available composition appears to provide a lower degree of anti-rewrinkling ability to the fabrics in comparison with the those non-film-forming compositions of the inventive method.

There are, of course, many alternative embodiments and modifications of the present invention which are intended to be included within the spirit and scope of the following claims.

What we claim is:

1. A method of dewrinkling and providing rewrinkling resistance to a fabric comprising the steps of
a) providing a target fabric;
b) spray-contacting said target fabric of step “a” with a composition comprising water and a fiber lubricant/plasticizer;
wherein said fiber lubricant/plasticizer is selected from the group consisting of high density polyolefin waxes, at least one compound that conforms with the following Formula (A)
at least one compound that conforms with the following Formula (A) 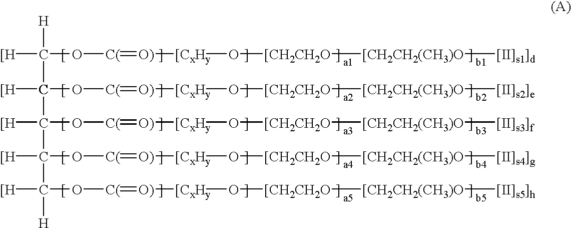
wherein d=f=h=1; e=0 or 1; g=0 or 1; 2≦x≦20; (2x−4)≦y≦2x; and
$$Σ {a}_{i} >= 8 and \frac{Σ {a}_{i} ( 44 )}{Σ {a}_{i} ( 44 ) + Σ {b}_{i} ( 56 )} >= 0.6 ;$$
wherein structure [II] is H, CH₃, or 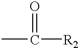
wherein R₂=CₚH_{q} such that 1≦p≦20, 2p−3≦q≦2p+1, and sᵢ=0 or 1; at least one compound that conforms with the following Formula (B)
[I]-[CH₂CH₂O—]ₐᵢ—[CH₂CH₂(CH₃)O—]_{bi}-[II]ₛᵢ (B)
wherein structure [I] is H, CH₃O, or R₁(O)_{c};
wherein R₁=CₙHₘ, and 2≦n≦20, (2n−4)≦m≦2n+1, 1≦c≦5, and
$$Σ {a}_{i} \geq 8 and \frac{Σ {a}_{i} ( 44 )}{Σ {a}_{i} ( 44 ) + Σ {b}_{i} ( 56 )} \geq 0.6 ;$$
wherein and Structure [II] is H, CH₃, or 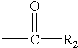
wherein R₂=CₚH_{q} such that 1≦p≦20, 2p−3≦q≦2p+1, and sᵢ=0 or 1;
wherein when Structure I is not H or CH₃, or Structure II is not H or CH₃, then 1≦i≦c
$$\sum {a}_{i} \geq 8 and \frac{\sum {a}_{i} ( 44 )}{\sum {a}_{i} ( 44 ) + \sum {b}_{i} ( 56 )} \geq 0.6 ;$$
wherein when Structure I is H or CH₃O and Structure II is H, then i=1 and a(44)+b(56)≧8000 and
$$\frac{a ( 44 )}{a ( 44 ) + b ( 56 )} \geq 0.6 ;$$
and any mixtures thereof.

2. The method of claim 2 wherein said fiber lubricant/plasticizer exhibits a HLB of greater than or equal to 8.0.

3. The method of claim 1 wherein said fiber lubricant/plasticizer is a high density polyolefin wax.

4. The method of claim 2 wherein said fiber lubricant/plasticizer is selected from the group consisting of alkoxylated fatty acid esters, alkoxylated fatty acid esters, polyoxyalkylene waxes, emulsified high density polyethylenes, alkoxylated alcohols, blends of any such compounds with salts, and any mixtures thereof

5. The method of claim 4 wherein said fiber lubricant/plasticizer is ethoxylated castor oil.

6. A fabric treated in accordance with the method of claim 1.

7. A fabric treated in accordance with the method of claim 2.

8. A fabric treated in accordance with the method of claim 3.

9. A fabric treated in accordance with the method of claim 4.

10. A fabric treated in accordance with the method of claim 5.

11. A method of dewrinkling and providing rewrinkling resistance to a fabric comprising the steps of
a) providing a target fabric;
b) spray-contacting said target fabric of step “a” with a non-film forming composition comprising water and a fiber lubricant/plasticizer; wherein said fiber lubricant/plasticizer is selected from the group consisting of high density polyolefin waxes, at least one compound that conforms with the following Formula (A) 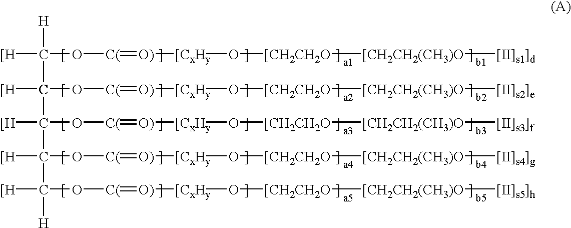
wherein d=f=h=1; e=0 or 1; g=0 or 1; 2≦x≦20; (2x−4)≦y≦2x; and
$$\sum {a}_{i} >= 8 and \frac{\sum {a}_{i} ( 44 )}{\sum {a}_{i} ( 44 ) + \sum {b}_{i} ( 56 )} >= 0.6 ;$$
wherein structure [II] is H, CH₃, or 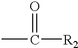
wherein R₂=CₚH_{q} such that 1≦p≦20, 2p−3≦q≦2p+1, and sᵢ=0 or 1; at least one compound that conforms with the following Formula (B)
[I]-[CH₂CH₂O—]ₐᵢ—[CH₂CH₂(CH₃)O—]_{bi}-[II]ₛᵢ (B)
wherein structure [I] is H, CH₃O, or R₁(O)_{c};
wherein R₁=CₙHₘ, and 2≦n≦20, (2n−4)≦m≦2n+1, 1≦c≦5, and
$$\sum {a}_{i} \geq 8 and \frac{\sum {a}_{i} ( 44 )}{\sum {a}_{i} ( 44 ) + \sum {b}_{i} ( 56 )} \geq 0.6 ;$$
wherein and Structure [II] is H, CH₃, or 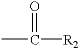
wherein R₂=CₚH_{q} such that 1≦p≦20, 2p−3≦q≦2p+1, and sᵢ=0 or 1;
wherein when Structure I is not H or CH₃, or Structure II is not H or CH₃, then 1≦i≦c
$$\sum {a}_{i} \geq 8 and \frac{\sum {a}_{i} ( 44 )}{\sum {a}_{i} ( 44 ) + \sum {b}_{i} ( 56 )} \geq 0.6 ;$$
wherein when Structure I is H or CH₃O and Structure II is H, then i=1 and a(44)+b(56)≧8000 and
$$\frac{a ( 44 )}{a ( 44 ) + b ( 56 )} \geq 0.6 ;$$
and any mixtures thereof.

12. The method of claim 11 wherein said fiber lubricant/plasticizer exhibits a HLB of greater than or equal to 8.0.

13. The method of claim 11 wherein said fiber lubricant/plasticizer is a high density polyolefin wax.

14. The method of claim 12 wherein said fiber lubricant/plasticizer is selected from the group consisting of alkoxylated fatty acid esters, alkoxylated fatty acid esters, polyoxyalkylene waxes, emulsified high density polyethylenes, alkoxylated alcohols, blends of any such compounds with salts, and any mixtures thereof

15. The method of claim 14 wherein said fiber lubricant/plasticizer is ethoxylated castor oil.

16. A fabric treated in accordance with the method of claim 11.

17. A fabric treated in accordance with the method of claim 12.

18. A fabric treated in accordance with the method of claim 13.

19. A fabric treated in accordance with the method of claim 14.

20. A fabric treated in accordance with the method of claim 15.
